(19) United States
(12) Patent Application Publication
(10) Pub. No.: US 2009/0117352 A1
(43) Pub. Date: May 7, 2009

(54) Component fabrication

(75) Inventors: Justin M. Burrows, Derby (GB); Jeffrey Allen, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 11/919,544

(22) PCT Filed: Apr. 6, 2006
(86) PCT No.: PCT/GB2006/001280

§ 371 Date: Oct. 30, 2007

(30) Foreign Application Priority Data
May 6, 2005 (GB) 0509263.0

(51) Int. Cl. B05D 5/00; B32B 3/00

(52) U.S. Cl. 428/209; 427/596

(57) ABSTRACT

Component fabrication and in particular fabrication by deposition processes for large components is made more convenient by initially depositing a masking deposition layer 2 upon a thin substrate 1 such that subsequently shaped metal deposition techniques can be used. Previously, the relatively thin nature of the substrate 1 has rendered the hot heat plume 11 of the shaped metal deposition technique too intrusive. It will be understood that this heat plume 11 may distort the thin substrate 1. By initial application of a protective masking deposition layer 2, the underlying substrate is protected by that layer 2 from the heat plume 11 generated by the shaped metal deposition process.

The present invention relates to component fabrication and more particularly to fabrication of relatively large components by deposition techniques.

Deposition techniques are utilised in order to form an approximate shape of a finished component or article by deposition of a powder or wire raw material upon a substrate. The principal deposition techniques are shaped metal deposition (SMD) and direct laser deposition (DLD). In either event, the raw material as indicated is in the form of a powder or wire which is rendered molten in order that through successive depositions, one upon the other, a particular component shape can be built to approximate the final component. Clearly, there is normally a final finishing stage where surface shaping and other features such as screw threads are formed in the component.

These deposition techniques have particular advantage where the base material is expensive and so machining processes from a solid stock body can be wasteful in terms of material loss. With a deposition technique a fabricated or hybrid route is followed where the shape of the finished component is built up from either powder or wire raw material, and then only the final machining process is performed.

SMD and DLD processes combine welding technology with computer aided design/computer aided manufacture systems to offer alternatives to current manufacturing technologies. Particular benefits relate to reducing the amount of production tooling required for prototypes, reducing component inventory through use of standard welding wire or powder metallic material as the basis for additive deposition, reduction in component lead time, design flexibility and provide an alternative to casting or forging where such processes may introduce structural problems within the component.

Generally, SMD depositions are more rapid allowing quicker manufacture of the approximate or net component shape, whilst DLD is a slower deposition process. Thus, SMD is more favourable for manufacture of large components but it has a significant disadvantage in that it cannot be applied with respect to relatively thin substrate, that is to say less than 10 mm thick. The SMD process incorporates a relatively high temperature and creates a thermal plume as it is deposited. This thermal plume will extend into the thin substrate from which the SMD deposition extends. Such a high temperature thermal plume will cause thermal distortion in the substrate and so possible failure of that substrate.

The DLD process, by use of a laser in order to create the deposition rather than a TIG or MIG welding process as with the SMD process utilises a far lower heat energy. In such circumstances there is less heat plume which can cause distortion of the base substrate from which the deposition process extends. Unfortunately the metal deposition rates of normal DLD systems is significantly lower than acceptable. Typically, a DLD system will achieve a deposition rate of only 50 grams of material per hour whilst an SMD system may achieve 500 grams per hour. In such circumstances, it will be appreciated that DLD systems are inappropriate for manufacture of large structural sections such as those of a compressor casing for a gas turbine engine. Nevertheless, as indicated previously, the unacceptably severe thermal distortion effects of the SMD is unacceptable, whilst the low deposition rates of DLD render both approaches unacceptable for large components which have a thin substrate base.

In accordance with the present invention there is provided a method of component fabrication comprising the steps of forming a masking deposition layer by direct laser deposition upon a substrate, adding a structural deposition layer by a shaped metal deposition to the masking deposition layer to form a component shape, the masking deposition layer being formed to a depth sufficient to mask a heat plume from the shaped metal deposition layer.

Generally, the method includes forming the deposition layer of sufficient thickness to ensure a shaped metal deposition process does not significantly thermally distort the substrate whereby that substrate is damaged.

Additionally, the substrate and masking deposition layer form a stable platform for subsequent shaped metal deposition processes.

Additionally, in accordance with the present invention there is provided a component fabrication intermediary comprising a substrate and a masking deposition layer formed by direct laser deposition, the masking deposition layer of sufficient depth to form a platform upon which shaped metal deposition processes can be performed without detrimental distortion of the substrate.

An embodiment of the present invention will now be described by way of example only with reference to the accompanying drawing illustrating a schematic cross section of a component fabrication in which;

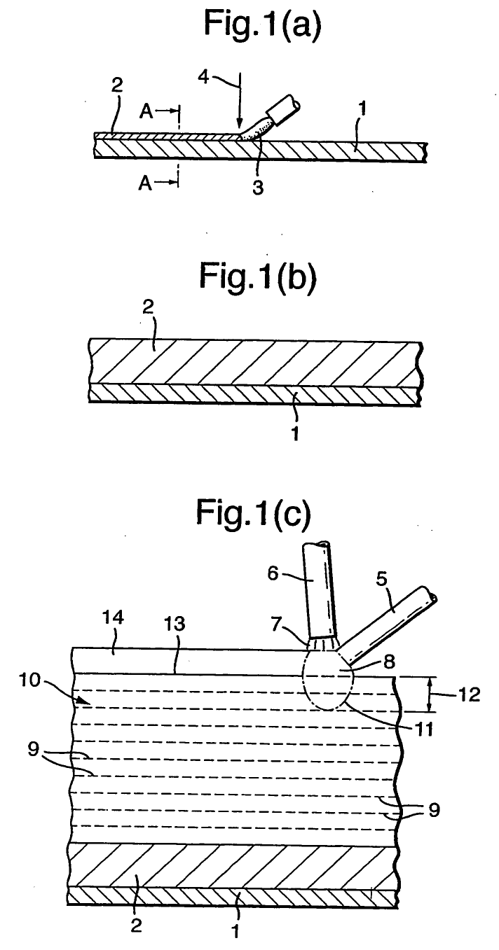

FIG. 1a illustrates direct laser deposition

FIG. 1b illustrates a masking deposition layer upon a substrate and;

FIG. 1c illustrates addition of a structural layer by shaped metal deposition.

The processes of shaped metal deposition (SMD) and direct laser deposition (DLD) are well known and generally involve presentation of a raw material such that it will be rendered molten to allow deposition either through an electrical arc in the shaped metal deposition process or through exposure to a laser beam in the direct laser deposition process. The reader is directed to relevant text books and other disclosures with regard to the inherent processes of shaped metal deposition and direct laser deposition techniques but these will be readily understood by those skilled in the technology.

A substrate is utilised in order to provide an initial structural frame upon which deposition can be performed. It will be understood that when forming such structures as tubes or compression rings, it is convenient to provide a thin walled tube or ring upon which the deposition process is initially performed. This thin walled substrate may itself remain a part of the component once formed or be machined or otherwise processed/removed from the component as required. In either event the substrate will be relatively thin and generally be no thicker than 10 millimetres. In such circumstances any distortion or cracking of the substrate may render the eventual component unacceptable.

The shaped metal deposition process as indicated involves creation of an arc consistent with TIG or MIG welding techniques in order that the raw material is rendered molten and a deposition layer laid down upon each pass. In such circumstances, each pass of the shaped metal deposition process will build up in order to form the component structure which as indicated may subsequently be machined or otherwise processed into a final form. Nevertheless the shaped metal deposition process does create a hot heat plume which will penetrate any substrate. If that substrate is thin as described above the thermal distortive effects of the heat plume may damage the substrate and therefore eventual component formed.

FIG. 1a illustrates a thin substrate 1 upon which a masking deposition layer 2 is formed by a direct laser deposition process. This direct laser deposition process involves presentation of a powder or wire 3 to the surface of the substrate 1 such that a directly applied laser beam 4 melts the powder or wire 3 into a molten state whereby it becomes fused with the substrate 1 as well as creates the masking deposition layer 2.

As indicated above, the direct laser deposition process is relatively slow with deposition rates of only 50 grams per hour. In such circumstances the masking deposition layer 2 is relatively thin. Furthermore, this low deposition rate for direct laser deposition would not be commercially viable in order to form large component structures such as compressor rings for a gas turbine engine.

FIG. 1b illustrates an expanded cross-section in the direction A-A depicted in FIG. 1a when the direct laser deposition process is completed in accordance with the method of the present invention. Thus, as can be seen the component pre cursor or intermediary formed as a combination of the substrate 1 and masking deposition layer 2 is a relatively stable platform in which the depth of the masking deposition layer acts as a protection for the substrate 1. As can be seen, generally the masking deposition layer 2 is thicker than the underlying substrate 1. However, the actual thickness of the masking deposition layer 2 will depend upon the heat characteristics of the material from which the masking deposition layer 2 is formed. It will be understood that this masking deposition layer 2 is essentially used in order to protect the substrate 1 from a heat plume as a result of the shaped metal deposition process subsequently applied to the platform comprising the substrate 1 and layer 2. In such circumstances depending upon the heat characteristics of the material from which the layer 2 is formed, the thickness of that layer may be varied to provide a convenient and viable balance between adequate depth for protection against the shaped metal deposition process heat plume against the time consideration of the limited direct laser deposition rate. In such circumstances the depth of the masked deposition layer 2 will depend upon knowledge of the subsequent shaped metal deposition process in terms of heat energy and heat plume characteristics.

FIG. 1c illustrates an expanded cross-section illustrating application of further material by shaped metal deposition technique upon the component pre cursor or intermediary formed by the substrate 1 and masking deposition layer 2 described with regard to FIG. 1a and FIG. 1b. Thus, as can be seen, a wire 5 is presented such that through an electrode 5 an electrical arc 7 is created such that molten material 8 is deposited to build up the walls or other parts of a component. As can be seen, by successive passes, illustrated by broken lines 9 the shaped metal deposition process is additive in order to form the structural wall 10 of the component.

Of particular concern with regard to the present invention is the presence of a heat plume 11 which extends into the already cooling layers of the component wall 10 to a depth 12 below a surface 13 of the most recently deposited layer of shaped metal deposition. This heat plume acts to at least partially re-melt the material of those layers such that there is fusion between the newly molten wire 5 caused by the arc 7 in order to create further deposition 14 upon the component wall 10. It is this heat plume which if the shaped metal deposition technique were applied directly to the substrate 1 would cause thermal distortion and therefore damage to that substrate 1.

In order to protect the substrate 1, the direct laser deposition process, as indicated above applies a masking deposition thereto. Thus, this masking deposition layer 2 must have sufficient depth that the heat plume 11 does not significantly affect the substrate 1 in order to create detrimental damage or distortion to that substrate 1. Clearly, the shape and depth 12 of the plume 11 may vary due to a number of factors including the intensity of the arc 7, type of material deposited and heat transfer characteristics. Nevertheless, by a combination of the relatively cool direct laser deposition process in order to provide the masking deposition thereto with the hotter but more rapid deposition rate of the shaped metal deposition process, it will be understood that large components can be more conveniently formed.

Generally, the depth of the masking deposition layer 2 will be chosen such that there is a degree of margin for error whereby the heat plume 11 does not detrimentally impinge upon the underlying substrate 1 for all foreseeable situations. Thus, it will be understood that in the course of shaped metal deposition there may be parts of the component wall 11 which require either greater width of deposition or at which there is linger of the electrode 6 and wire 5 in order to create a structural feature whereby the heat plume 11 may increase in size in comparison with the usual depth 12. In such circumstances the masking deposition layer 2 should similarly be configured such that the heat plume 11, even though of increased depth 12 does not impinge upon the substrate 1.

The direct laser deposition process in providing the masking deposition layer 2 creates a structurally stable platform with the substrate 1. This platform is a component pre cursor or intermediary for the subsequent major deposition processes performed by the shaped metal deposition process as described above. In such circumstances the minimal heat input attributable to the direct laser deposition process acts to minimise distortion of the substrate 1 in creating the structurally stable platform to act as a component pre cursor. Generally the direct laser deposition technique can be employed utilising coaxial or external power feed with an optic fibre directing a laser beam 4 from a YAG, diode or CO₂ laser source.

As indicated, the shaped metal deposition process, whether it utilises TIG or MIG welding techniques or not, is employed to complete the deposition in order to form a component structure which can then be finally machined to shape. The effects of thermal distortion caused by shaped metal deposition is minimised due to the protective effect of the masking deposition layer 2 upon the structurally stable platform comprising that layer 2 and the substrate 1. In such circumstances, as indicated previously, the direct laser deposition process must create a masking deposition layer which is of sufficient thickness, depth and volume to prevent thermal distortion of the original thin walled substrate 1.

By a combination of the direct laser deposition and shaped metal deposition processes as indicated above it is more convenient to manufacture large components by deposition techniques.

1. A method of component fabrication comprising the steps of forming a masking deposition layer by direct laser deposition upon a substrate adding a structural deposition layer by shaped metal deposition to the masking deposition layer to form a component shape, the masking deposition layer being formed to a depth sufficient to mask a heat plume from the shaped metal deposition layer.

2. A method as claimed in claim 1 wherein the masking deposition layer is of sufficient thickness to ensure a shaped metal deposition process does not significantly thermally distort the substrate whereby that substrate is damaged.

3. A method as claimed in claim 1 wherein the substrate and the masking deposition layer form a stable platform for subsequent shaped metal deposition processes.

4. A component fabrication intermediary comprising a substrate and a masking deposition layer formed by direct laser deposition, the masking deposition layer being of sufficient depth to form a platform upon which a shaped metal deposition process is performed without detrimental distortion of the substrate.

5. A turbine engine component incorporating a component fabricated according to the method of claim 1.

6. A turbine engine component formed utilising a component fabrication intermediary as claimed in claim 4.

7. A method as claimed in claim 2 wherein the substrate and the masking deposition layer form a stable platform for subsequent shaped metal deposition processes.
